(19) United States
(12) Patent Application Publication
(10) Pub. No.: US 2023/0030839 A1
(43) Pub. Date: Feb. 2, 2023

(54) INBOUND LOAD DELIVERY-TYPE PREDICTOR

(71) Applicant: Walmart Apollo, LLC, Bentonville, AR (US)

(72) Inventors: Mohit Choudhary, Bentonville, AR (US); Manoj Krishna Kukkala, Bentonville, AR (US); Charls Antony, Bentonville, AR (US)

(21) Appl. No.: 17/384,160

(22) Filed: Jul. 23, 2021

(51) Int. Cl. G05D 1/02; G06Q 10/08

(52) U.S. Cl. CPC G05D 1/0225; G06Q 10/0833; G05D 1/0223; G06Q 10/087; G05D 2201/0213

(57) ABSTRACT

Examples provide a delivery-type predictor for automatically determining a delivery-type of an incoming load of items. The delivery-type predictor identifies a dominating vendor from a plurality of vendors supplying a plurality of items the incoming load bound for a distribution center (DC), fulfillment center (FC) or other delivery destination. The dominating vendor is a vendor providing a majority of items in the load. Historical data associated with previous delivery-types of previous loads associated with the dominating vendor are analyzed to generate a predicated delivery-type for the incoming load. If historical data is unavailable, destination data describing a department in a DC or FC is analyzed to generate the prediction. If historical data and department data are unavailable, the delivery-type predictor analyzes warehouse area data to generate the prediction. The prediction identifies whether the incoming load should be designated a live-type delivery or a drop delivery.

### BACKGROUND

Trucks carrying loads of product to a distribution center (DC), warehouse or other destination can be classified as either live-type delivery or drop-type delivery. A drop-type delivery occurs where a driver detaches the trailer containing product at the destination, at which time, the driver is free to leave in the truck. The trailer dropped off at the destination can be unloaded by personnel whenever it is convenient. In contrast, live-type delivery typically involves a driver waiting with the truck and trailer at the destination until personnel unload the product from the trailer, at which time the driver leaves with the trailer still connected to the truck. Consequently, it is more urgent to unload live-type deliveries quickly and efficiently, which requires reservation of sufficient personnel and other resources at the destination during the expected truck arrival time window. Where a delivery type is unknown, the default is to assign a live-type delivery designation to the load to avoid fees and other problems associated with having insufficient resources available to unload a live-type delivery when the truck arrives. However, incorrectly assigning a live delivery designation to drop-type deliveries can be costly and result in inefficient management of DC resources and suboptimal scheduling of deliveries.

### SUMMARY

Some examples provide a system for predicting delivery-type of an incoming load. The system includes a data storage device storing historical data associated with a plurality of vendors and at least one memory communicatively coupled to at least one processor. The memory includes computer-readable instructions configured to, with the at least one processor, execute a delivery-type predictor to select a dominating vendor from the plurality of vendors providing at least one item in the plurality of items associated with the incoming load for delivery to the destination. The dominating vendor is a vendor providing a majority of items in the plurality of items for delivery to the destination. The delivery-type predictor identifies a delivery-type probability of the incoming load based on historical data associated with the selected dominating vendor is available in response to determining the historical data associated with the dominating vendor is available. The historical data includes at least one previous delivery-type assigned to at least one previous load comprising at least one item provided by the selected dominating vendor, the delivery-type probability comprising at least one of a probability the incoming load is live or a probability the incoming load is a drop. A delivery-type prediction for the incoming load is generated based on the delivery-type probability identified selected dominating vendor based on the analyzed historical data. The delivery-type prediction comprising a predicted delivery-type for the incoming load.

Other examples provide a method for predicting delivery-type of an incoming load. A delivery-type predictor identifies a delivery-type probability of an incoming load based on historical data associated with a dominating vendor selected from a plurality of vendors contributing a plurality of items to the incoming load for delivery to a destination in response to determining the historical data associated with the dominating vendor is available. A delivery-type prediction for the incoming load is generated based on the delivery-type probability identified selected dominating vendor based on the analyzed historical data. The predicted delivery-type is assigned to the incoming load.

Still other examples provide a computer storage devices having computer-executable instructions stored thereon. On execution by a computer, the computer-executable instructions cause the computer to perform operations including selecting a dominating vendor from the plurality of vendors providing at least one item in the plurality of items associated with the incoming load for delivery to the destination. A delivery-type probability is calculated for the incoming load based on historical data associated with the selected dominating vendor is available in response to determining the historical data associated with the dominating vendor is available. A delivery-type prediction for the incoming load is generated based on the delivery-type probability identified for the selected dominating vendor based on the analyzed historical data. The predicted delivery-type is assigned to the incoming load.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for predicting delivery-type of an incoming load.

FIG. 2 is an exemplary block diagram illustrating a delivery-type predictor.

FIG. 3 is an exemplary block diagram illustrating a delivery-type predictor for generating a predicted delivery-type of a load.

FIG. 4 is an exemplary block diagram illustrating a dominating vendor selector for identifying a dominating vendor.

FIG. 5 is an exemplary block diagram illustrating a data storage device storing historical data, destination data, and load data for predicting delivery-type.

FIG. 6 is an exemplary flow chart illustrating operation of the computing device to select a dominating vendor.

FIG. 7 is an exemplary flow chart illustrating operation of the computing device to designate a delivery-type of a load.

FIG. 8 is an exemplary flow chart illustrating operation of the computing device to assign a predicted delivery-type to a load.

FIG. 9 is an exemplary flow chart illustrating operation of the computing device to override a predicted delivery-type based on vendor-specific rules.

FIG. 10 is an exemplary flow chart illustrating operation of the computing device to update a delivery-type based on vendor request.

FIG. 11 is an exemplary table illustrating a table showing accuracy data for delivery-type predictions generated by a delivery-type predictor over a one-year time period.

FIG. 12 is an exemplary table illustrating vendor, load and destination data used to calculate delivery-type probabilities.

FIG. 13 is an exemplary table illustrating destination data for a distribution center for calculating live and drop delivery-type probabilities.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable delivery-type prediction for an incoming load to a destination, such as, but not limited to, a distribution center (DC) and/or a fulfillment center (FC). A delivery type can include a drop delivery-type or a live delivery-type. In some examples, the system analyzes historical data associated with previous delivery-types of previous loads associated with a dominating vendor. A probability that the incoming load is live and/or a probability that the incoming load is drop is calculated based on the previous delivery-types of loads associated with the dominating vendor. This enables more accurate prediction of delivery-type while reducing the number of drop loads erroneously assigned a live delivery-type. This improves resource usage and reduces costs associated with deliveries to DCs and FCs.

Aspects of the disclosure further enable selection of a dominating vendor for each incoming load. The delivery-type for the load is predicted based on historical delivery-type of previous loads associated with the dominating vendor. This enables more accurate and efficient designation of delivery-types for loads.

The computing device executing the delivery-type predictor operates in an unconventional manner by automatically predicting a delivery-type for each load based on historical data and/or load data. The predicted delivery-type is used to schedule incoming loads as drop or live without manual, human intervention. In this manner, the computing device is used in an unconventional way, and allows more accurate determination of delivery-type without user input, thereby improving the functioning of the underlying computing device.

The delivery-type predictor eliminates inefficient scheduling for delivery types based on predicted delivery-types for incoming loads rather than assigning a default live delivery-type to incoming loads. This improves resource utilization and increases delivery capacity while reducing manual inputs from vendors and carriers.

The delivery-type predictor provides accurate prediction of delivery type of inbound trailers. The predictor algorithm predicts delivery type of new vendors and new carriers, as well as pre-existing vendors and carriers. This enables automated decision making of delivery type without manual touches for improved accuracy allowing improved utilization of resources and increased delivery capacity.

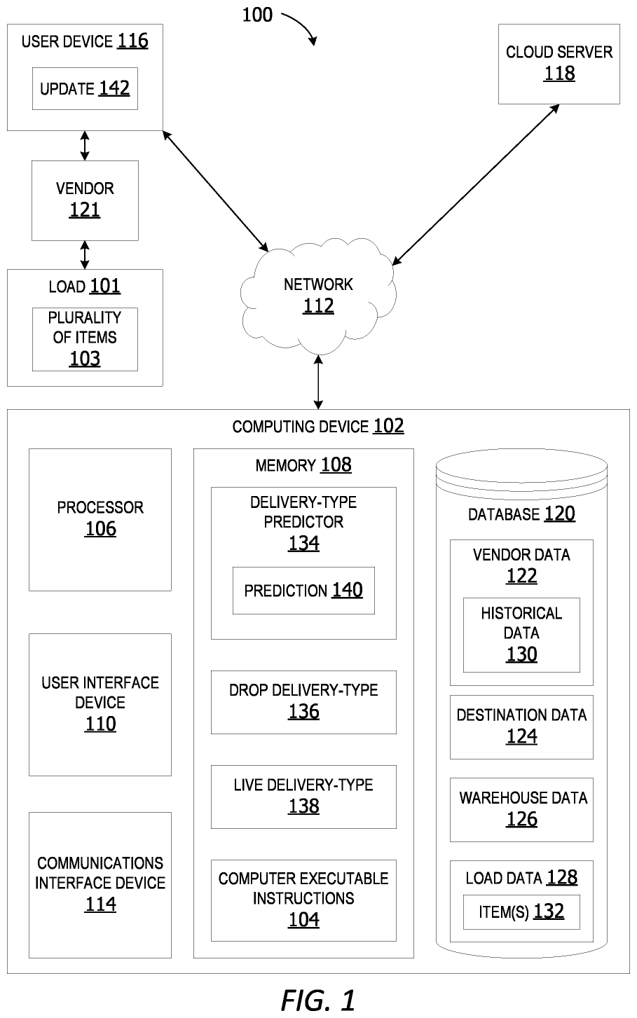

Referring again to FIG. 1, an exemplary block diagram illustrates a system 100 for predicting delivery-type of an incoming load 101. The load includes a plurality of items 103 loaded onto a trailer or other transport vehicle for delivery to a destination, such as, but not limited to, a DC or FC. The plurality of items 103 are provided by one or more vendors in a plurality of vendors. The vendor(s) can be an individual or a business entity, such as a partnership or corporation. The vendor(s) can include a manufacturer of the item(s), an entity assembling components into an item, and/or a supplier receiving items from a manufacturer or other vendor.

In the example of FIG. 1, the computing device 102 represents any device executing computer-executable instructions 104 (e.g., as application programs, operating system functionality, or both) to implement the operations and functionality associated with the computing device 102. The computing device 102, in some examples, includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 in other examples includes a user interface device 110.

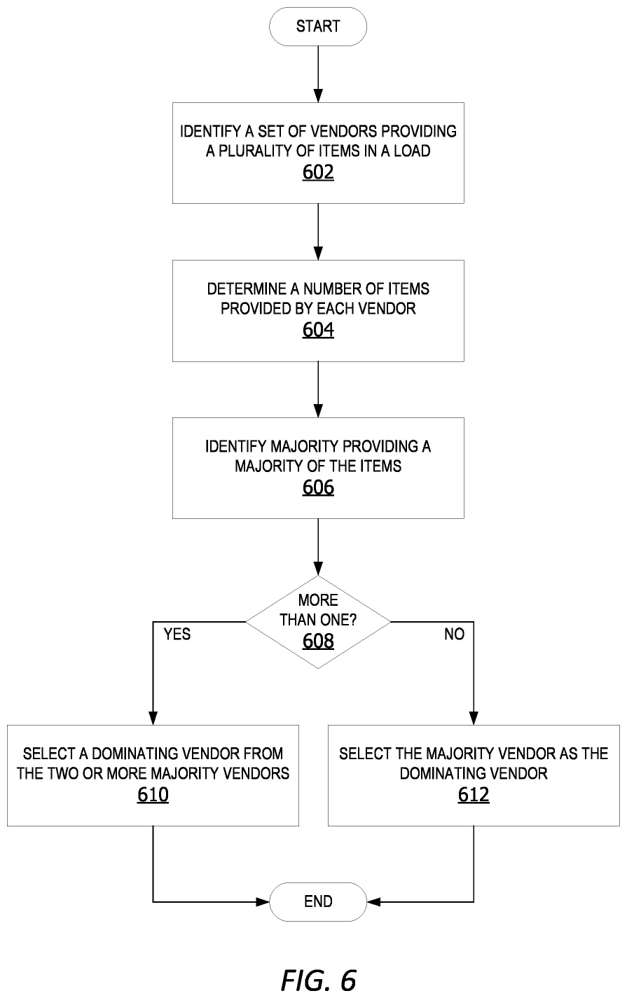

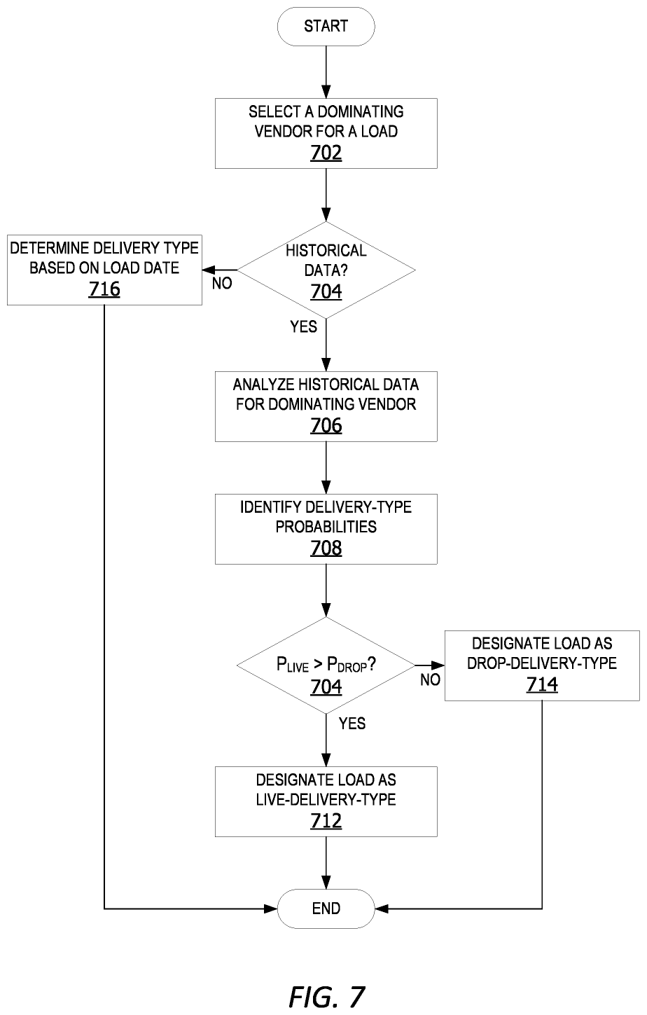

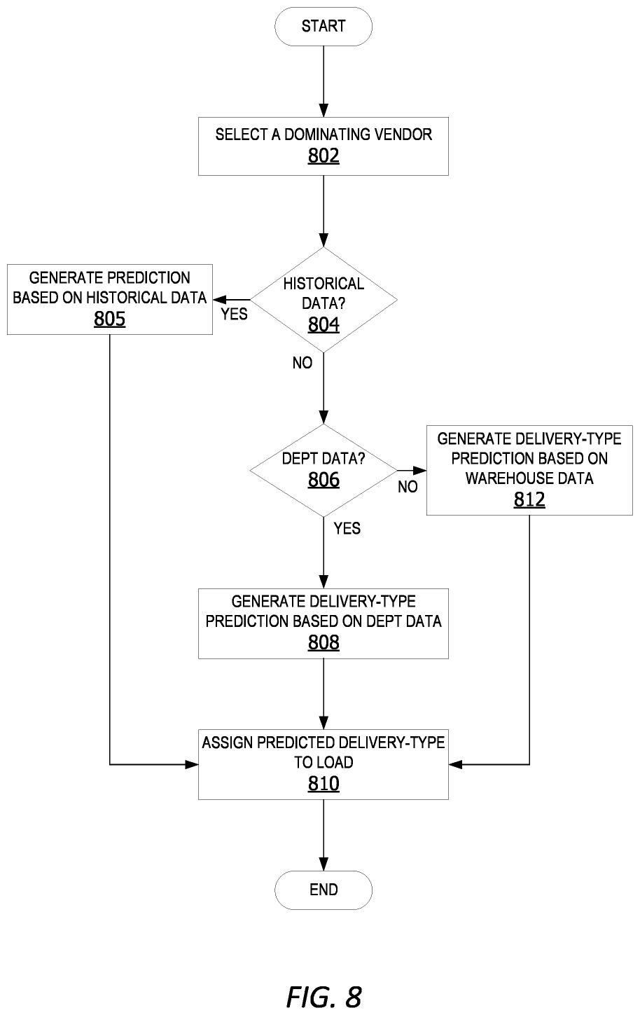

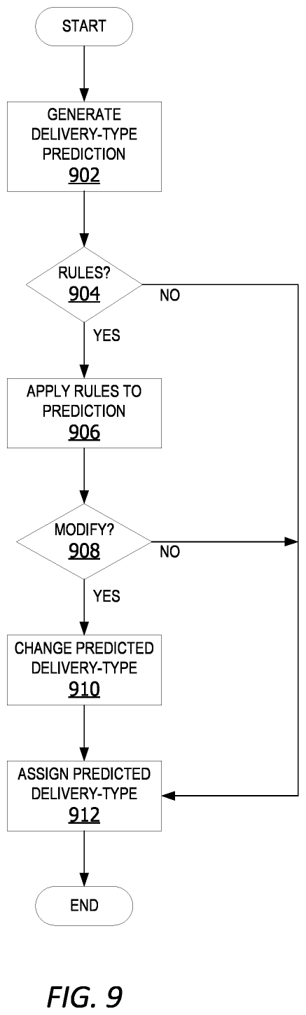

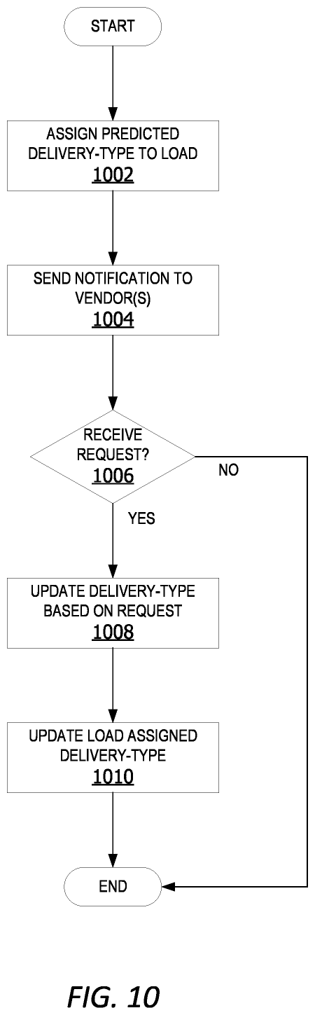

The processor 106 includes any quantity of processing units, and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, FIG. 8, FIG. 9, and FIG. 10).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to, a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device. In this non-limiting example, the user device is a computing device associated with a vendor, such as, but not limited to, the vendor 121. The vendor 121 is an entity providing one or more items to the incoming load 101 bound for a DC or FC. In this non-limiting example, the vendor 121 is a dominating vendor selected from a plurality of vendors providing items in the load.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 120 for storing data, such as, but not limited to vendor data 122, destination data 124, warehouse data 126 and/or load data 128. In this non-limiting example, the vendor data 122, destination data 124, warehouse data 126 and/or load data 128 is stored on a physical data store associated with the computing device 102. However, in other examples, the vendor data 122, destination data 124, warehouse data 126 and/or load data 128 can be stored in whole or in part on a cloud data store.

The vendor data 122 includes historical data 130 associated with each vendor in a plurality of vendors contributing one or more items to the incoming load 101. The plurality of items 103 contributed by the one or more vendor(s) can be individual items, items stored in cases (boxes) and/or items on pallets. The historical data 130 includes previous delivery-types assigned to previous loads having items provided by one or more of the vendor(s). The historical data includes the number of previous loads which were drop delivery-type and the number of loads which were designated live delivery-type. If a vendor is a new vendor, historical data for previous loads may be unavailable. The system predicts the probability the incoming load 101 is a live load, or a drop load based on the number of previous loads which were live or drop.

The destination data 124 is data describing departments within a DC, FC, or other destination. In some examples, the destination data 124 identifies one or more departments associated with the item(s) in the incoming load 101. For example, if the load 101 includes meat products, the destination data 124 identifies a meat department as the department in the destination to which the item(s) are assigned. Other departments in a DC or destination can include bakery, freezer, produce, clothing, etc. The destination data can be used to predict whether the load 101 is live or drop. For example, if the destination department identified in the destination data 124 is the meat department, the system predicts the load 101 is a live delivery-type due to the perishable nature of meat products which cannot be left sitting in a dropped trailer.

The warehouse data 126 is data describing an area in a warehouse associated with item(s) 132 in the incoming load 101. The warehouse data 126, in some examples, includes a dry goods area, a meat and produce area, as well as a freezer and dairy area. The system utilizes the warehouse data 126 to predict the delivery-type of the load 101. For example, if the warehouse data 126 indicates the item(s) 132 in the incoming load 101 are assigned to the dry goods area, the system predicts a drop delivery-type due to the non-perishable nature of dry goods.

The load data 128 is data describing the plurality of items 103 on the load. The load data 128 includes data obtained from purchase orders for items in the load 101. Each vendor can have a single purchase order or multiple purchase orders. Each purchase order can cover a single item as well as multiple items. The load data for a single load may include dozens of purchase orders. The load data also includes number of cases, contents of cases, numbers of items on the load, etc.

The data storage device 120 can include one or more different types of data storage devices, such as, for example, one or more rotating disks drives, one or more solid state drives (SSDs), and/or any other type of data storage device. The data storage device 120 in some non-limiting examples includes a redundant array of independent disks (RAID) array. In other examples, the data storage device 120 includes a database. The database stores the vendor data 122, destination data 124, warehouse data 126 and/or load data 128 in one or more data tables, such as, but not limited to, relational data tables.

The data storage device 120 in this example is included within the computing device 102, attached to the computing device, plugged into the computing device, or otherwise associated with the computing device 102. In other examples, the data storage device 120 includes a remote data storage accessed by the computing device via the network 112, such as a remote data storage device, a data storage in a remote data center, or a cloud storage.

The memory 108 in some examples stores one or more computer-executable components, such as, but not limited to, a delivery-type predictor 134 component. The delivery-type predictor 134 is a software component executed by the processor 106 of the computing device 102.

The delivery-type predictor 134 calculates a delivery-type probability of an incoming load 101 based on the historical data 130 associated with a dominating vendor 121 selected from a plurality of vendors contributing the plurality of items 103 to the incoming load 101 for delivery to a destination in response to determining the historical data 130 associated with the dominating vendor 121 is available. The historical data 130 includes at least one previous delivery-type assigned to at least one previous load comprising at least one item provided by the selected dominating vendor 121. The delivery-type probability includes at least one of a probability the incoming load is a live delivery-type 138 or a probability the incoming load 101 is a drop delivery-type 136. In some examples, the probability is a probability value, such as, but not limited to, a percentage value.

The delivery-type predictor 134 generates a delivery-type prediction for the incoming load based on the delivery-type probability identified selected dominating vendor 121 based on the analyzed historical data 130. The delivery-type prediction 140 includes a predicted delivery-type for the incoming load. The delivery-type predictor 134 assigns the predicted delivery-type to the incoming load 101.

In some examples, the delivery-type predictor 134 analyzes the destination data 124 to generate the prediction 140. The destination data 124 can be used in additional to the historical data and/or the destination data 124 can be used in place of the historical data 130. In other words, the delivery-type predictor 134 utilizes the destination data 124 in response to a determination the historical data 130 for the dominating vendor 121 is unavailable. The historical data may be unavailable if the dominating vendor 121 is a new vendor or records associated with previous items shipped in previous loads cannot be found in the data store. The destination data 124 includes an identification of at least one department associated with at least one item provided by the dominating vendor 121 is available. The department is a department in a DC or FC. The delivery-type predictor 134 generates the delivery-type prediction based on the destination data 124.

In other examples, the delivery-type predictor 134 analyzes warehouse data 126 identifying at least one warehouse area associated with at least one item in the load. In some examples, the warehouse data is data identifying a warehouse area for items provided by the dominating vendor 121. The system can utilize the warehouse data 126 in addition to the historical data 130 and/or the destination data 124 to create the predication 140. In other examples, the delivery-type predictor 134 only uses the warehouse data 126 if the historical data 130 and the destination data 124 is unavailable. The delivery-type predictor 134 generates the delivery-type prediction based on the warehouse data 126. The delivery-type of the prediction is assigned to the incoming load. The delivery-type is published to the vendors, such as, but not limited to, the vendor 121.

In some examples, the delivery-type predictor 134 receives an update requesting the predicted delivery-type of the load be changed. For example, if the predicted delivery-type is live, the vendor 121 can request the delivery-type be changed to drop, and vice-versa. If an update 142 is received from one or more vendors, the delivery-type predictor 134 automatically changes the assigned delivery-type to the requested delivery-type.

In this example, the delivery-type predictor is executed on a computing device 102. In other examples, the delivery-type predictor 134 is executed in whole or in part on the cloud server.

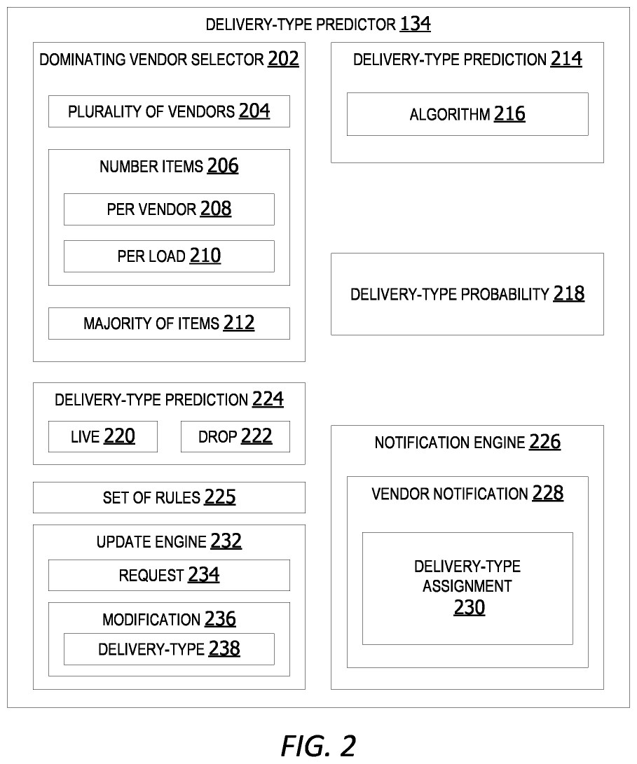

FIG. 2 is an exemplary block diagram illustrating a delivery-type predictor 134. The delivery-type predictor 134, in some examples, includes a dominating vendor selector 202. The dominating vendor selector 202 selects a dominating vendor from a plurality of vendors contributing the plurality of items to an incoming load. In some examples, the dominating vendor selector 202 determines a number of items 206 supplied on a per-vendor 208 and per-load 210 basis. A vendor contributing a majority of items 212 to a single load is selected as the dominating vendor for that load. If two or more vendors qualify as majority vendors providing a majority of items 212 to the load, where each of the majority vendors contribute the same number of items and no other vendor provides more items than the two or more majority vendors, the dominating vendor selector 202 randomly selects a dominating vendor from the set of two or more majority vendors. In other examples, the dominating vendor selector 202 selects a dominating vendor from the set of majority vendors based on which vendor has the most historical data available associated with previous delivery-types of previous loads associated with each vendor.

The delivery-type prediction 214 algorithm 216 analyzes the historical data for the dominating vendor to generate a delivery-type probability 218. The delivery-type probability 218 includes a probability value indicating a probability the incoming load is a live 220 or drop 222. The delivery-type prediction 224 software component generates a predicted delivery-type for the load based on the delivery-type probability for the load being a live 220 or drop 222.

In some examples, the algorithm 216 includes the following:

$${V}_{id} = {\sum }_{p = 1}^{m} {\sum }_{l = 1}^{n} {C}_{ipl}$$

where V_{id} is the volume of vendor i on Delivery d. In this non-limiting example, C is number of cases, n is the number of items in a purchase order. Here p is number of purchase order for vendor i in delivery d. In some examples, the dominating vendor is identified in accordance with the following:

D_{d}=Max{V_{1d},V_{2d},V_{3d},V_{4d}, . . . , V_{od}}

where D_{d} is the dominating vendor on delivery d and o is the total number of vendors in the delivery (load).

$${P}_{x} ( Live ) = {\sum }_{d = 1}^{p} \frac{{L}_{d}}{{L}_{d} + {D}_{d}} \\ {L}_{d} = 1 if delivery d was live \\ {D}_{d} = 1 if delivery d was drop$$

Pₓ(Live) is the probability of a vendor x being a live-type delivery and p is the total number of deliveries for a dominating vendor. In some examples, the algorithm 216 shows an eighty-seven percent accuracy over schedulers using default live-type assignments which show only a sixty-one percent accuracy.

The delivery-type predictor 134 analyzes a set of rules 225 to determine if the predicted delivery-type should be modified. The set of rules 225 are business rules specific to each vendor. The rules can specify that certain vendors should always be associated with a specific delivery-type. In other words, the set of rules 225 can override the delivery-type prediction. For example, if the set of rules specifies delivery-type for a vendor A should always be drop-type, the rules can override a delivery-type prediction for a live-type delivery if vendor A is providing a threshold number of items in the load. In another example, a rule in the set of rules can specify that if the dominating vendor is vendor B, the load is always assigned a live 220 delivery-type. Thus, if the delivery-type prediction is drop and the dominating vendor is vendor B, the set of rules override the prediction to change the delivery-type from the predicted drop delivery-type to the rules-specified delivery-type of live 220 delivery-type.

When the delivery-type is determined, a notification engine 226 optionally sends a vendor notification 228 to each vendor associated with a given load to notify each vendor of the delivery-type assignment 230. If one or more vendor(s) objects to the delivery-type assignment 230, the vendor(s) can send a request 234 to the delivery-type predictor 134. The request 234 is a request to change the delivery-type 238. In response to receiving the update request 234, an update engine 232 performs a modification 236 of the delivery-type 238.

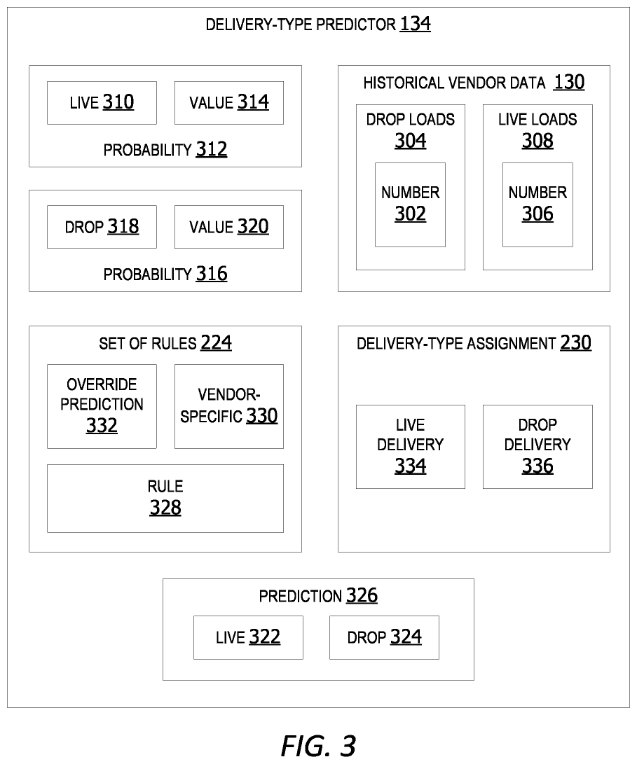

FIG. 3 is an exemplary block diagram illustrating a delivery-type predictor 134 for generating a predicted delivery-type of a load. In some examples, the delivery-type predictor 134 analyzes historical data 130 to generates a delivery-type prediction. The historical data 130 includes a number 302 of drop loads 304 associated with a dominating vendor. The historical data 130 in other examples includes a number 306 of live loads 308 associated with the dominating vendor.

From the historical data 130, the delivery-type predictor 134 generates a live 310 probability 312 value 314 representing the probability that the incoming load should be a live delivery-type. The delivery-type predictor 134 in other examples generates a drop 318 probability 316 value 320 indicating the probability that the incoming load should be a drop load. In some examples, the delivery-type predictor 134 generates a live probability 312. In other examples, the delivery-type predictor 134 generates a drop 318 probability 316. In still other examples, the delivery-type predictor 134 generates both a live 310 probability 312 value 314 and a drop 318 probability 316 value 320. The probabilities are used to generate the predicted delivery-type.

In some examples, if the live 310 probability 312 value 314 is greater than the drop 318 probability 316 value 320, the predicted delivery-type is a live delivery-type. If the live 310 probability 312 value 314 is less than the drop 318 probability 316 value 320, the predicted delivery-type is a drop delivery-type. In one example, the live probability is calculated as:

$${P}_{LIVE} = \frac{Instances of LIVE}{Total Instances}$$

The probability of the load being a drop load is calculated as:

$${P}_{DROP} = \frac{Instances of DROP}{Total Instances}$$

The load is predicted to be a live load if:

P_{LIVE}>P_{DROP}

Likewise, the load is predicted to be a drop load if:

P_{DROP}>P_{LIVE}

The set of rules 225 are applied in some examples to the live 322 or drop 324 prediction 326 generated by the delivery-type predictor 134. If a vendor-specific 330 rule 328 in the set of rules 225 indicates the predicted delivery-type should be changed, the delivery-type predictor 134 automatically updates or modifies the delivery-type assignment 230 in accordance with the rule 328. For example, if the delivery-type assignment 230 is a live delivery 334, the delivery-type predictor 134 can automatically change the delivery-type assignment 230 to a drop delivery 336 if required by the rule 328.

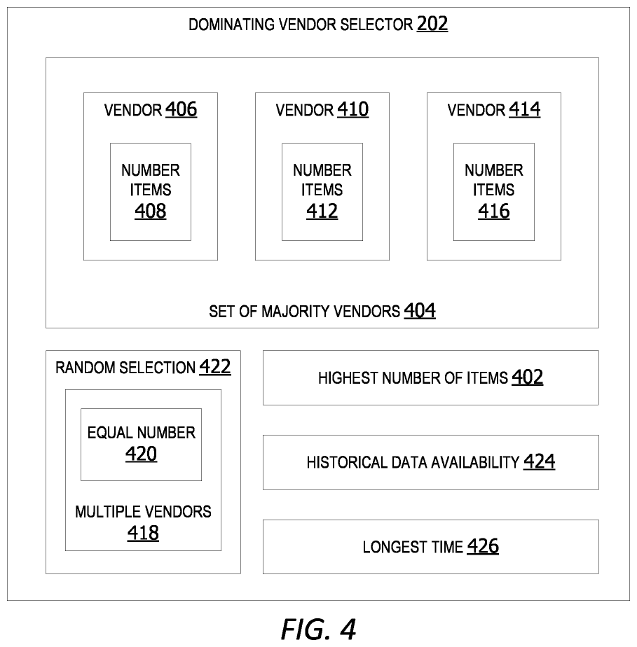

FIG. 4 is an exemplary block diagram illustrating a dominating vendor selector 202 for identifying a dominating vendor. In some examples, the dominating vendor selector 202 identifies a number of items in a given load provided by each vendor. The vendor contributing a majority of the items 402 to the load is selected as the dominating vendor. If multiple vendors 418 are identified as majority vendors providing a majority of items, where each vendor contributes an equal number 420 of items and no other vendor contributes more items than the multiple majority vendors, the system chooses a dominating vendor from the set of majority vendors 404.

In one example, if a first vendor 406 contributes a first number of items 408, a second vendor 410 contributes a second number of items 412 and a third vendor 414 contributes a number of items 416, the dominating vendor selector 202 selects the vendor having the greatest number of items. Thus, if vendor 406 provides 100 items, vendor 410 provides 1200 items and vendor 414 contributes 600 items, vendor 410 is the dominating vendor.

However, if vendor 406, vendor 410 and vendor 414 all contribute the same number of vendors and that number is the greatest number of items provided by any vendor, then all three vendors are members of the set of majority vendors 404. Each of the vendors in the set of majority vendors 404 qualify to be a dominating vendor. In some examples, a random selection 422 is performed to randomly select a vendor from the set of majority vendors 404.

In other examples, the dominating vendor selector 202 selects a vendor from the set of majority vendors 404 based on historical data availability 424. In these examples, if historical data is available for vendor 406 but not for vendor 410 or 414, then vendor 406 is selected as the dominating vendor. In other examples, if historical data is available for two or more of the majority vendors in the set of majority vendors 404, the dominating vendor selector 202 selects the vendor based on the amount of historical data for each vendor. Thus, if more historical data is available for vendor 414 than for vendor 406 or vendor 410, the dominating vendor selector 202 selects vendor 414.

In still other examples, a vendor is selected from the set of majority vendors 404 based on the longest time 426 during which historical data for the vendor has been accumulated. Thus, if historical data for vendor 406 only goes back one month, historical data for vendor 410 goes back for 6 months but historical data for vendor 414 goes back two years, then vendor 414 is selected as the dominating vendor.

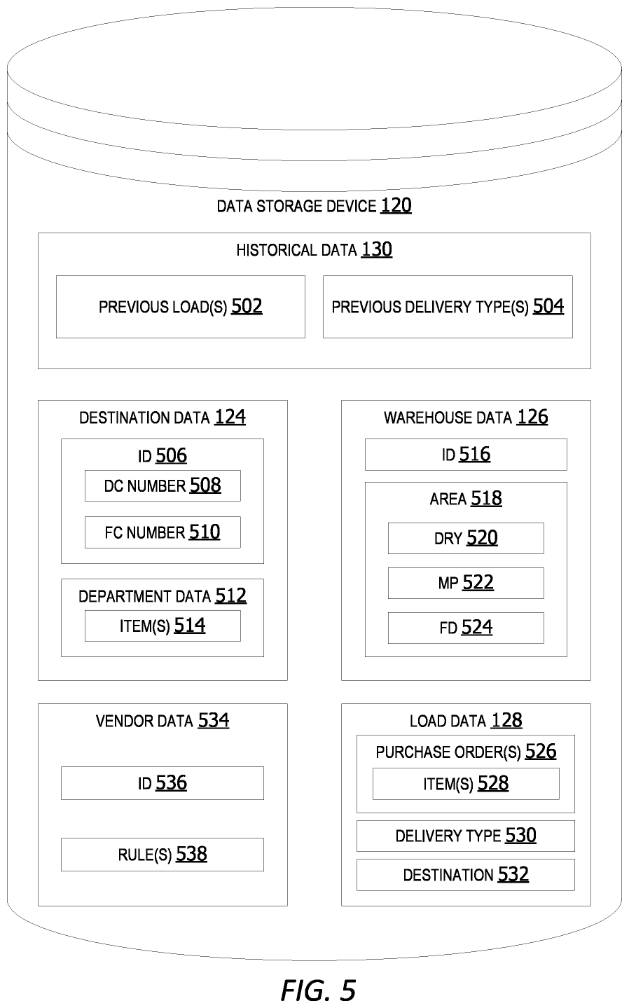

FIG. 5 is an exemplary block diagram illustrating a data storage device 120 storing historical data 130, destination data 124, warehouse data 126 and/or load data 128 for predicting delivery-type. In some examples, the historical data 130 includes data describing previous load(s) for which the vendor(s) provided item(s) and/or previous delivery-type(s) 504 of loads associated with the dominating vendor.

Destination data 124 is data describing a destination of a load. The destination data 124 includes an identification (ID) 506, including a DC number 508 identifying a DC and/or a FC number 510 identifying a fulfillment center. The destination data 124 in other examples, includes department data 512 describing or identifying a department within a DC or FC for one or more item(s) 514 in the load.

The warehouse data 126, in some examples, includes a warehouse ID 516 identifying a warehouse and/or an area 518 of a warehouse associated with one or more item(s) in the incoming load. The area 518 of the warehouse in some examples includes three areas, a dry 520 area for dry goods, an MP 522 area for meat and produce, and/or a FD 524 area for freezer and dairy items.

The load data 128, in some examples, includes purchase order(s) 526 for one or more item(s) 528, delivery-type 530, and/or destination 532 of the load. The vendor data 534 includes vendor ID 536 and/or one or more rule(s) 538 associated with each vendor.

FIG. 6 is an exemplary flow chart illustrating operation of the computing device to select a dominating vendor. The process shown in FIG. 6 is performed by a delivery-type predictor component, executing on a computing device, such as the computing device 102.

The process begins by identifying a set of one or more vendors providing a plurality of items in a load at 602. The delivery-type predictor determines a number of items provided by each vendor at 604. The delivery-type predictor identifies one or more majority vendor(s) providing a majority of the items at 606. A majority vendor is a vendor providing the majority of items in the load. A determination is made whether more than one majority vendor is identified at 608. If yes, a single dominating vendor is selected from the two or more majority vendors at 610. The dominating vendor can be selected randomly or selected based on the amount or availability of the historical data for each vendor. If only a single majority vendor is identified at 608, the majority vendor is selected as the dominating vendor at 612. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to designate a delivery-type of a load. The process shown in FIG. 7 is performed by a delivery-type predictor component, executing on a computing device, such as the computing device 102.

The process begins by selecting a dominating vendor for a load at 702. A determination is made whether historical data is available for the dominating vendor at 704. If yes, the delivery-type predictor analyzes the historical data for the dominating vendor at 706. The delivery-type predictor identifies delivery-type probabilities for the dominating vendor at 708. The delivery-type probabilities include a probability that the load is a live delivery-type (P_{LIVE}) and/or a probability the load is a drop delivery-type (P_{DROP}). A determiantion is made whether the probability of live delivery-type is greater than the probability of drop delivery-type at 710. If yes, the load is designated as a live delivery-type at 712. If no, the delivery-type is designated as drop delivery-type at 714. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to assign a predicted delivery-type to a load. The process shown in FIG. 8 is performed by a delivery-type predictor component, executing on a computing device, such as the computing device 102.

The process begins by selecting a dominating vendor at 802. A determination is made whether historical data is available for the dominating vendor at 804. If yes, the delivery-type prediction is generated based on the historical data at 805. The predicted delivery-type is assigned to the load at 810.

If historical data is unavailable at 804, a determination is made whether department data is available at 806. The department data is data associated with a department at a DC, FC, or other destination for one or more items in the load associated with the dominating vendor. If yes, a delivery-type prediction is generated based on the department data at 808. The predicted delivery-type is assigned to the load at 810.

If department data is unavailable at 806, the delivery-type prediction is generated based on warehouse data 812 associated with one or more items in the load. The predicted delivery-type is assigned to the load at 810. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an exemplary flow chart illustrating operation of the computing device to override a predicted delivery-type based on vendor-specific rules. The process shown in FIG. 9 is performed by a delivery-type predictor component, executing on a computing device, such as the computing device 102.

The process begins by generating a delivery-type prediction at 902. A determiantion is made whether any vendor-specific rules associated with one or more vendors providing items in the load are applicable at 904. If yes, the rules are applied to the prediction at 906. A determiantion is made whether to modify the delivery-type prediction based on the rules at 908. If yes, the predicted delivery-type is changed in accordance with the one or more rules at 910. The predicted delivery-type is assigned to the load at 912. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an exemplary flow chart illustrating operation of the computing device to update a delivery-type based on vendor request. The process shown in FIG. 10 is performed by a delivery-type predictor component, executing on a computing device, such as the computing device 102.

The process begins by assigning a predicted delivery-type to a load at 1002. A notification is sent to the vendor(s) associated with the load at 1004. A determiantion is made whether a request to modify the delivery-type is received from one or more of the vendor(s) at 1006. If yes, the delivery-type is updated based on the request at 1008. The updated load is assigned to the delivery-type at 1010. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

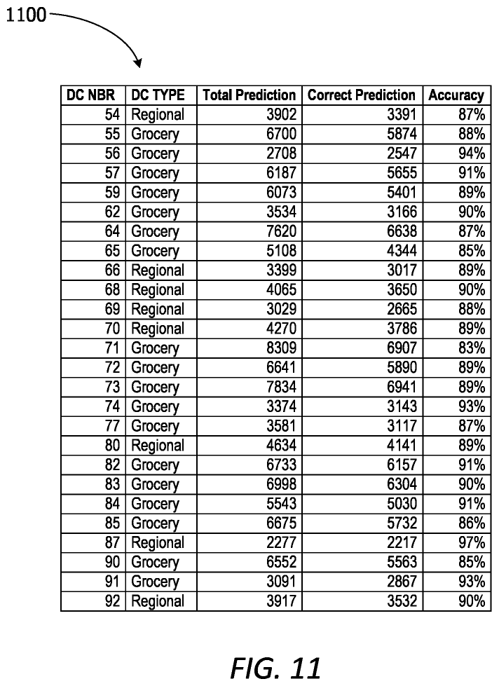

FIG. 11 is an exemplary table 1100 illustrating a table showing accuracy data for delivery-type predictions generated by a delivery-type predictor over a one-year time period. As shown here, the predictions generated by the system show 85% and higher accuracy results for delivery-type predictions.

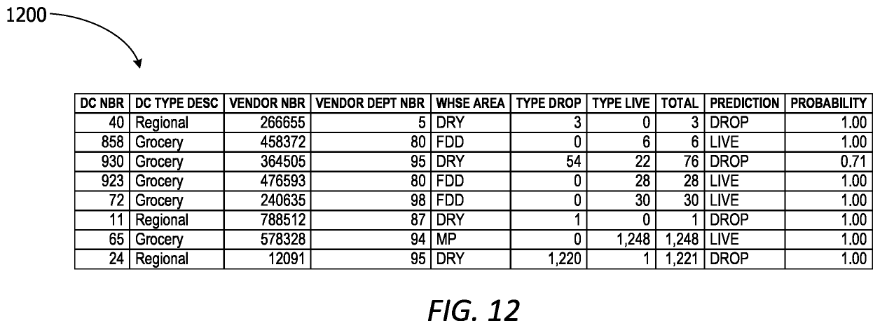

FIG. 12 is an exemplary table 1200 illustrating vendor, load and destination data used to calculate delivery-type probabilities. The predictor looks at characteristics of a dominating vendor for a distribution center to predict delivery type. If the dominating vendor is not available in historical data, the system looks at the dominating vendor department number for a DC to predict the delivery-type. If the department number is not available, the system looks at probabilities of warehouse area for a DC for the prediction.

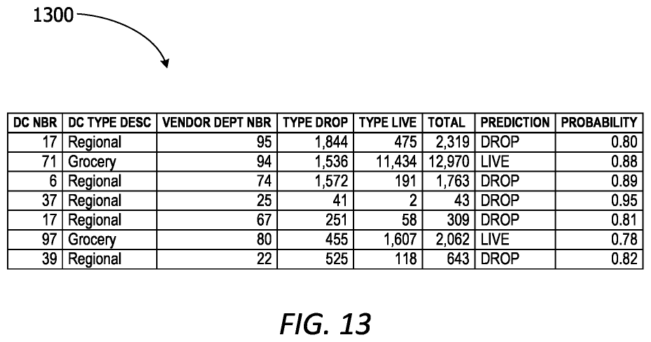

FIG. 13 is an exemplary table 1300 illustrating destination data for a distribution center for calculating live and drop delivery-type probabilities. In this example, various probabilities of live loads and drop loads are shown based on DC department area for items of the incoming load.

In some examples, the system checks business rules to override the prediction with business logic. If not, the system utilizes the predicted delivery-type for the delivery-type designation of the load.

In some examples, the system identifies the contents of a load/cases per vendor/all vendors based on purchase orders for the load. The system identifies the dominating vendor (vendor having largest number of cases). The system looks at historical behavior of the dominating vendor to predict whether the load is live or drop. If no historical vendor data is available, the system looks at the DC number and DC department of goods for dominating vendor. If there is no DC department data, the system looks at warehouse area of cases for the dominating vendor. The system automatically assigns delivery type without manual intervention of users. Users can override/update or alter the assigned delivery type.

### Additional Examples

In some examples, the delivery-type predictor algorithm predicts delivery type for inbound loads based upon load configuration. The algorithm predicts the delivery type with higher accuracy. The algorithm has automated decision making resulting in the elimination of manual touches. The system further exposes the API, accessed via one or more applications running on one or more user devices, making the system beneficial across teams, groups, departments, etc. The system provides easier acceptance and easier integration in production environment than other solutions with improved results. In some examples, the delivery-type predictor performs better, providing more accurate results, than logistic regression and other solutions sixty-one percent (61%) of the time.

In an example scenario, the system utilizes vendor number, department data, warehouse area data, DC number and item/case data describing the contents of pallets and/or cases in the load. The system determines if historical data associated with the dominating vendor is available. If yes, the system generates a delivery-type prediction based on the historical data. If historical data is unavailable, the system analyzes department data and/or warehouse data to generate the predicted delivery-type. The system determines if this is a special case or business logic (rules) apply to the load. If so, the prediction is modified in accordance with the special case and/or rules if necessary. The predicted delivery-type is assigned to the load for scheduling of personnel and resources at the destination for unloading of the trailer during the arrival window for the trailer. If the load is live, more resources are allocated for quicker unloading of the trailer.

In other examples, the predictive algorithm is exposed as a service and is deployed in cloud infrastructure. The system has no impact to the purchase order priority (POP) service level agreements (SLAs). The algorithm runs independent of POP. The algorithm can be executed even when POP is stopped due to other reasons.

All the logic is integrated into the API. The user provides the inputs for the API. The algorithm access input data via one or more tables. The tables may be stored via a data storage device, database, cloud storage, or any other type of data storage. The delivery-type predictor algorithm accesses the input data, such as, but not limited to, the warehouse data, load data, destination data, and historical data. In other examples, the input data includes a delivery number, vendor number, vendor department number, warehouse area and/or DC number. The predicted delivery type is entered as an appointment type code.

The system supports any load that is coming into a DC or other destination. The system obtains vendor data, load data, destination data and warehouse data from a database or other data tables. The system knows which vendors are providing items/cases, what department they belong to, what warehouse area and which DC it is going to, etc. For the dominating vendor, the system calculates or identifies pre-calculated probabilities for live or drop load based on historical data for the dominating vendor at vendor level. The database table can include data such as, but not limited to, historical vendor data (number live loads, number drop loads), probabilities of live for each vendor and/or probability of drop for each vendor.

In some examples, if a vendor is new, there is no historical information for the vendor. In such cases, the system uses department data. The department indicates perishable items, such as meat, produce or dairy, the load is likely live. If the department indicates the items on the load are typically drop items, the load is predicted to be a drop load.

If the system does not have vendor or department data, the system goes to warehouse area data. If the warehouse area is meat and produce or freezer and dairy, it is predicted to be a live load. If the warehouse area of the item(s)/case(s) is dry goods, the load is predicted to be drop.

In some examples, the dominating vendor is the vendor having the highest number of cases on the truck/trailer. The system calculates the probability of live or drop based on the probability how many times the dominating vendor items/cases were live and drop.

In an example scenario, if an incoming truck is associated with cases from ten different vendors, the system calculates the number of cases for each vendor. Each vendor has one or more purchase orders indicating how many cases/boxes for each vendor. The system adds all items in each purchase order for each vendor. If vendor 1 has 1000 cases, vendor 2 has 900 cases and vendor 3 has 700 cases, the dominating vendor is vendor 1 with 1000 cases.

The prediction is used to tell vendors to arrive on a scheduled date and appointment time as either a drop or live delivery. The order management system communicates with this scheduling system. The scheduler tells trucks/trailers when to arrive and whether they are live or drop. The scheduler determines that automatically. If the vendor does not like the scheduled live or drop, the vendor can manually call to change the delivery from live to drop. This results in more accurate scheduling, decreases manual touches and requires fewer vendor requests to change the delivery-type.

In another example, the system identifies all vendors/manufacturers providing cases of goods which are on an incoming truck/trailer. The system identifies the dominating vendor. The dominating vendor is the vendor providing the majority of the cases in the load on the truck/trailer. If there are two or more vendors providing equal numbers of cases such that a single dominating vendor cannot be identified, the system selects a dominating vendor at random from among those providing the highest number of cases. For example, if there are 100 cases and vendor A provides 40 cases, vendor B provides 40 cases and vendor C provides 20 cases, the system randomly selects a dominating vendor from between vendor A and vendor B.

The system analyzes information associated with the inventory of the cases and/or historical information associated with the dominating vendor to predict whether the load will be a live load requiring manual unloading within a short period of time after arrival of the truck to the DC or a drop load in which the trailer of cases is simply left at the DC for unloading whenever convenient. In other words, a DROP load does not require immediate unloading while a LIVE load requires

Alternatively, or in addition to the other examples described herein, examples include any combination of the following:
determine whether destination data comprising an identification of at least one department associated with at least one item provided by the dominating vendor is available;
analyze the destination data in response to the determination the destination data is available;
generate the delivery-type prediction based on the destination data;
analyze warehouse data identifying at least one warehouse area associated with at least one item provided by the dominating vendor in response to the determination the warehouse data is available;
generate the delivery-type prediction based on the warehouse data;
check a set of rules associated with the dominating vendor to determine whether at least one rule in the set of rules overrides the predicted delivery-type;
change the predicted delivery-type in accordance with the at least one rule in response to the determination the at least one rule overrides the predicted delivery-type;
determine the predicted delivery-type independent of a purchase order prioritization associated with the incoming load;
deploy the delivery-type predictor on a cloud server;
receive a request from at least one vendor associated with the incoming load, the request comprising an update requesting a change of the assigned delivery-type;
change the assigned delivery-type responsive to the request;
select the dominating vendor from the plurality of vendors providing at least one item in the plurality of items associated with the incoming load for delivery to the destination, the dominating vendor is a vendor providing a majority of items in the plurality of items for delivery to the destination.
perform a random selection of the dominating vendor from a set of majority vendors in response to identifying two or more vendors contributing an equal numbers of items to the incoming load, and wherein each vendor in the set of majority vendors qualifies as a potential dominating vendor.

At least a portion of the functionality of the various elements in FIG. 1, FIG. 2, FIG. 3, FIG. 4, FIG. 5, and FIG. 6 can be performed by other elements in FIG. 1, FIG. 2, FIG. 3, FIG. 4, FIG. 5 and FIG. 6, or an entity (e.g., processor 106, web service, server, application program, computing device, etc.) not shown in FIG. 1, FIG. 2, FIG. 3, FIG. 4, FIG. 5, and FIG. 6.

In some examples, the operations illustrated in FIG. 6, FIG. 7, FIG. 8, FIG. 9, and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of predicting a delivery-type of a load of items bound for a destination, the method comprising identifying a delivery-type probability of an incoming load based on historical data associated with a dominating vendor selected from a plurality of vendors contributing a plurality of items to the incoming load for delivery to a destination in response to determining the historical data associated with the dominating vendor is available, the historical data comprising at least one previous delivery-type assigned to at least one previous load comprising at least one item provided by the selected dominating vendor, the delivery-type probability comprising at least one of a probability the incoming load is live or a probability the incoming load is a drop; generating a delivery-type prediction for the incoming load based on the delivery-type probability identified selected dominating vendor based on the analyzed historical data, the delivery-type prediction comprising a predicted delivery-type for the incoming load; and assigning the predicted delivery-type to the incoming load.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for predicting delivery-type of incoming loads. For example, the elements illustrated in FIG. 1, FIG. 2, FIG. 3, FIG. 4, and FIG. 5, such as when encoded to perform the operations illustrated in FIG. 6, FIG. 7, FIG. 8, FIG. 9, and FIG. 10, constitute exemplary means for selecting a dominating vendor from the plurality of vendors providing at least one item in the plurality of items associated with the incoming load for delivery to the destination; exemplary means for calculating a delivery-type probability of the incoming load based on historical data associated with the selected dominating vendor is available in response to determining the historical data associated with the dominating vendor is available; exemplary means for generating a delivery-type prediction for the incoming load based on the delivery-type probability identified for the selected dominating vendor based on the analyzed historical data; and exemplary means for assigning the predicted delivery-type to the load.

Other non-limiting examples provide one or more computer storage devices having a first computer-executable instructions stored thereon for providing a delivery-type prediction for an incoming load. When executed by a computer, the computer performs operations including selecting a dominating vendor from the plurality of vendors providing at least one item in the plurality of items associated with the incoming load for delivery to the destination, the dominating vendor is a vendor providing a majority of items in the plurality of items for delivery to the destination; identifying a delivery-type probability of the incoming load based on historical data associated with the selected dominating vendor is available in response to determining the historical data associated with the dominating vendor is available, the historical data comprising at least one previous delivery-type assigned to at least one previous load comprising at least one item provided by the selected dominating vendor, the delivery-type probability comprising at least one of a probability the incoming load is live or a probability the incoming load is a drop; and generating a delivery-type prediction for the incoming load based on the delivery-type probability identified selected dominating vendor based on the analyzed historical data, the delivery-type prediction comprising a predicted delivery-type for the incoming load, wherein the predicted delivery-type is assigned to the incoming load.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or” “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either”, “one of”, “only one of”, or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for predicting delivery-type of an incoming load, the system comprising:
a data storage device storing historical data associated with a plurality of vendors; and
at least one memory communicatively coupled to at least one processor, the at least one memory comprising computer-readable instructions, the at least one least one memory and the computer-readable instructions configured to, with the at least one processor, execute a delivery-type predictor, to cause the at least one processor to:
select a dominating vendor from the plurality of vendors providing at least one item in a plurality of items associated with the incoming load for delivery to a destination, the dominating vendor is a vendor providing a majority of items in the plurality of items for delivery to the destination;
identify a delivery-type probability of the incoming load based on the historical data associated with the selected dominating vendor is available in response to determining the historical data associated with the dominating vendor is available, the historical data comprising at least one previous delivery-type assigned to at least one previous load comprising at least one item provided by the selected dominating vendor, the delivery-type probability comprising at least one of a probability the incoming load is live or a probability the incoming load is a drop; and
generate a delivery-type prediction for the incoming load based on the delivery-type probability identified selected dominating vendor based on the historical data, the delivery-type prediction comprising a predicted delivery-type for the incoming load, wherein the predicted delivery-type is assigned to the incoming load.

2. The system of claim 1, wherein the delivery-type predictor is further executed to cause the at least one processor further comprising:
determine whether destination data comprising an identification of at least one department associated with at least one item provided by the dominating vendor is available;
analyze the destination data in response to the determination the destination data is available; and
generate the delivery-type prediction based on the destination data.

3. The system of claim 2, wherein the delivery-type predictor is further executed to cause the at least one processor further comprising:
analyze warehouse data identifying at least one warehouse area associated with at least one item provided by the dominating vendor in response to the determination the warehouse data is available; and
generate the delivery-type prediction based on the warehouse data.

4. The system of claim 1, wherein the delivery-type predictor is further executed to cause the at least one processor further comprising:
check a set of rules associated with the dominating vendor to determine whether at least one rule in the set of rules overrides the predicted delivery-type; and
change the predicted delivery-type in accordance with the at least one rule in response to the determination the at least one rule overrides the predicted delivery-type.

5. The system of claim 1, wherein the delivery-type predictor is further executed to cause the at least one processor further comprising:
determine the predicted delivery-type independent of a purchase order prioritization associated with the incoming load.

6. The system of claim 1, wherein the delivery-type predictor is further executed to cause the at least one processor further comprising:
deploy the delivery-type predictor on a cloud server.

7. The system of claim 1, wherein selecting the dominating vendor further comprises:
perform a random selection of the dominating vendor from a set of majority vendors in response to identifying two or more vendors contributing an equal numbers of items to the incoming load, and wherein each vendor in the set of majority vendors qualifies as a potential dominating vendor.

8. A computer-implemented method for predicting delivery-type of an incoming load, the computer-implemented method comprising:
identifying a delivery-type probability of the incoming load based on historical data associated with a dominating vendor selected from a plurality of vendors contributing a plurality of items to the incoming load for delivery to a destination in response to determining the historical data associated with the dominating vendor is available, the historical data comprising at least one previous delivery-type assigned to at least one previous load comprising at least one item provided by the selected dominating vendor, the delivery-type probability comprising at least one of a probability the incoming load is live or a probability the incoming load is a drop;
generating a delivery-type prediction for the incoming load based on the delivery-type probability identified selected dominating vendor based on the historical data, the delivery-type prediction comprising a predicted delivery-type for the incoming load; and
assigning the predicted delivery-type to the incoming load.

9. The computer-implemented method of claim 8, further comprising:
analyzing destination data in response to a determination the historical data associated with the dominating vendor is unavailable, the destination data comprising an identification of at least one department associated with at least one item provided by the dominating vendor is available; and
generating the delivery-type prediction based on the destination data.

10. The computer-implemented method of claim 9, further comprising:
analyzing warehouse data identifying at least one warehouse area associated with at least one item provided by the dominating vendor in response to the determination the warehouse data is available; and
generating the delivery-type prediction based on the warehouse data.

11. The computer-implemented method of claim 8, further comprising:
checking a set of rules associated with the dominating vendor to determine whether at least one rule in the set of rules overrides the predicted delivery-type; and
changing the predicted delivery-type in accordance with the at least one rule in response to the determination the at least one rule overrides the predicted delivery-type.

12. The computer-implemented method of claim 8, further comprising:
receiving a request from at least one vendor associated with the incoming load, the request comprising an update requesting a change of the assigned delivery-type; and
changing the assigned delivery-type responsive to the request.

13. The computer-implemented method of claim 8, further comprising:
selecting the dominating vendor from the plurality of vendors providing at least one item in the plurality of items associated with the incoming load for delivery to the destination, the dominating vendor is a vendor providing a majority of items in the plurality of items for delivery to the destination.

14. The computer-implemented method of claim 13, further comprising:
selecting, via a random selection, the dominating vendor from a set of majority vendors in response to identifying two or more vendors contributing an equal numbers of items to the incoming load, and wherein each vendor in the set of majority vendors qualifies as a potential dominating vendor.

15. One or more computer storage devices having computer-executable instructions stored thereon, which, on execution by a computer, cause the computer to perform operations comprising:
select a dominating vendor from a plurality of vendors providing at least one item in a plurality of items associated with an incoming load for delivery to a destination, the dominating vendor is a vendor providing a majority of items in the plurality of items for delivery to the destination;
calculate a delivery-type probability of the incoming load based on historical data associated with the selected dominating vendor is available in response to determining the historical data associated with the dominating vendor is available, the historical data comprising at least one previous delivery-type assigned to at least one previous load comprising at least one item provided by the selected dominating vendor, the delivery-type probability comprising at least one of a probability the incoming load is live or a probability the incoming load is a drop;
generate a delivery-type prediction for the incoming load based on the delivery-type probability identified for the selected dominating vendor based on the historical data, the delivery-type prediction comprising a predicted delivery-type for the incoming load; and
assign the predicted delivery-type to the load.

16. The one or more computer storage devices of claim 15, wherein the operations further comprise:
analyze destination data in response to a determination the historical data associated with the dominating vendor is unavailable, the destination data comprising an identification of at least one department associated with at least one item provided by the dominating vendor is available; and
generate the delivery-type prediction based on the destination data.

17. The one or more computer storage devices of claim 16, wherein the operations further comprise:
analyze warehouse data identifying at least one warehouse area associated with at least one item provided by the dominating vendor in response to the determination the warehouse data is available; and
generate the delivery-type prediction based on the warehouse data.

18. The one or more computer storage devices of claim 15, wherein the operations further comprise:
check a set of rules associated with the dominating vendor to determine whether at least one rule in the set of rules overrides the predicted delivery-type; and
change the predicted delivery-type in accordance with the at least one rule in response to the determination the at least one rule overrides the predicted delivery-type.

19. The one or more computer storage devices of claim 15, wherein the operations further comprise:
determine the predicted delivery-type independent of a purchase order prioritization associated with the incoming load.

20. The one or more computer storage devices of claim 15, wherein the operations further comprise:
randomly select the dominating vendor from a set of majority vendors in response to identifying two or more vendors contributing an equal numbers of items to the incoming load, and wherein each vendor in the set of majority vendors qualifies as a potential dominating vendor.
